(19) United States
(12) Patent Application Publication
(10) Pub. No.: US 2010/0300869 A1
(43) Pub. Date: Dec. 2, 2010

(54) Micro-fluidic separating device for liquid mixtures

(75) Inventors: Hans-Richard Kretschmer, Berlin (DE); Oliver Lade, Berlin (DE); Arkadij M. Elizarov, Woodland Hills, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 12/791,083

(22) Filed: Jun. 1, 2010

(30) Foreign Application Priority Data
May 29, 2009 (DE) 102009024801.3
May 17, 2010 (EP) PCT/EP2010/056709

(51) Int. Cl. B01D 3/14

(52) U.S. Cl. 203/40; 210/175; 202/185.1

(57) ABSTRACT

The invention involves a micro-fluidic separation device for liquid mixtures with different boiling points. According to the invention it is intended that a head and a sump are formed in a separating channel; further intended is a thermo unit along the entire length of the separating channel consisting preferably of individually controllable heating and/or cooling elements. This makes it advantageously possible to perform a rectification of the liquid mixture with the separating device where individual fractions of the liquid mixture may be removed via the outlets. This allows continuous operations of the separating device at a simultaneously high degree of efficiency of the separation.

### CROSS-REFERENCE TO RELATED APPLICATIONS

This application claims priority to German application serial number 10 2009 024 801.3, filed on May 29, 2009, which is incorporated herein by reference in its entirety.

### FIELD OF THE INVENTION

The invention involves a micro-fluidic separating device for separating components from a solution. In one particular application, the device is configured for separating liquid mixtures containing fluids having varying boiling points. The device is comprised of an inlet for the liquid mixture and several outlets for the separated substances that are connected by or in communication via a channel system. In addition, heating and/or cooling elements may be in communication with or attached to the separating device. The heating and/or cooling elements may be in communication with the channel system via thermal conduction.

### BACKGROUND

JP 2007-136280 A shows a separating device. This separator works on the basis of the distillation principle. It is comprised of an inlet for the liquid mixture in the form of an elongated channel that is separated such that the more volatile substance may be vaporized when the liquid mixture is heated. The lighter substance can subsequently be removed from the designated outlet of the separator whereas the less volatile liquid remains in the system and in turn, may be removed via another outlet. The micro-fluidic separator is made out of parts consisting of several layers.

U.S. Pat. No. 5,441,719 describes procedures for the separation of liquid mixtures. This procedure referred to as “rectification” is in contrast to conventional distillation, whereby the separation effect for the components entailed in the liquid mixture is several times higher as compared to distillation.

In micro technology pursuant to DE 101 62 801 A1, structural modifications may also be made to the micro reactor in order to increase the interface, by reactions between gases and liquids.

### SUMMARY

In one aspect, the present invention is a microfluidic separation device comprising a sump, a head disposed above the sump, a separation channel, the head and sump in fluid communication via the separation channel, a heating element in communication with the sump, an inlet in fluid communication with the separation channel and an outlet in fluid communication with the separation channel.

By microfluidic, it is meant that the system is configured to manipulate, transfer, process, facilitate, etc. microliters and/or nanoliters of reagents. Channels, vessels, chambers, etc. used in the present invention may have at least one cross-sectional dimension (e.g., height, width, depth, diameter) from about 1 to about 1,000 μm, alternately from about 1 to about 500 μm, or even from about 10 to about 500 μm. The micro-channels make it possible to manipulate extremely small volumes of liquid on the order of nL to μL.

The channels may have a cross section of less than about 1 mm, less than about 0.5 mm, less than about 0.3 mm, or less than about 0.1 mm. The flow channels may also have a cross section dimension in the range of about 0.05 microns to about 1,000 microns, or 0.5 microns to about 500 microns, or about 10 microns to about 300 microns. The device may process about 5 μL to about 1000 μL of liquids.

In another aspect, the present invention is a microfluidic separation device configured to separate a mixture of at least two liquids, each having different boiling points, the device comprising a sump, a head above the sump, a separation channel positioned between the head and sump, the head and sump in fluid communication via the separation channel, a heating element in communication with the sump, a cooling element in communication with the head, an inlet in communication with the separation channel, an outlet in communication with the separation channel, wherein the head is in communication with the separation channel via a return channel.

In another aspect, the present invention is a method of using a microfluidic separation device configured to separate a mixture of at least two liquids, each having different boiling points, the device comprising a sump, a head disposed above the sump, a separation channel, the head and sump in fluid communication via the separation channel, an inlet in communication with the separation channel and an outlet in communication with the separation channel, the method comprising introducing into the inlet, a mixture of at least two liquids each having different boiling points, passing the mixture through the separation channel, heating the mixture, collecting a substance of a more volatile liquid of the mixture in the head, collecting a substance of a less volatile liquid of the mixture in the sump and passing at least a portion of the substance of the more volatile liquid or the less volatile liquid through the outlet.

In another aspect, the present invention is a method of using a microfluidic separation device configured to separate a mixture of at least two liquids, each having different boiling points. The device comprises a sump, a head disposed above the sump, a separation channel, the head and sump in fluid communication via the separation channel, an inlet in communication with the separation channel, and an outlet in communication with the separation channel, the method comprising continuously introducing into the inlet, a mixture of at least two liquids each having different boiling points, continuously passing the mixture through the separation channel, continuously heating the mixture, continuously collecting a more volatile liquid of the mixture in the head, continuously collecting a less volatile liquid of the mixture in the sump, and continuously passing at least a portion of the substance of the more volatile liquid or the less volatile liquid through the outlet.

In another aspect, the present invention is a microfluidic separation device for separating components of a solution, the device comprising a separation chamber, an inlet in communication with the separation chamber, an outlet in communication with the separation chamber and a heating or cooling element in operative communication with the separation chamber.

In another aspect, the present invention is a method for continuous solvent exchange and separation of a solution comprising different components, using a microfluidic separation device comprising a separation chamber, an inlet in communication with the separation chamber, a plurality of outlets, each in communication with the separation chamber and a heating and/or cooling element in operative communication with the separation chamber. The method comprises continuosly introducing the solution into the separation chamber through the inlet, continuously heating and/or cooling the solution in the separation chamber with the heating and/or cooling element to continuosly separate components from the solution, continuously passing at least one of the separated components from one outlet and continuously passing another one of the separated components from one outlet.

An objective of the present invention is to bring about a micro-fluidic separator that allows an efficient micro-fluidic separation of liquid mixtures in a short time with a high throughput. It is noted that the present invention may separate various solutions including a mixture of liquids having different boiling points. Another solution may include a solution with a solute, which is a non-volatile compound and wherein the solvents are volatile and vice versa.

It is noted that the present invention and methods of using may be used in a process of synthesizing radiochemicals including radiopharmaceuticals. In particular, the devices, systems and methods of the present invention may be used to synthesize radioactive compounds for imaging, such as by positron emission tomography (PET). Such radioactive compounds may comprise ¹⁸F.

This objective will be accomplished with the help of the aforementioned micro-fluidic separation unit of the present invention that is characterized by the fact that the channel system features a separation channel whose ends preferably consist of a head and a sump for rectification. The respective positions of the head and sump take advantage of gravity; in particular, the ends may be at different height levels. In addition, heating and/or cooling elements may be attached or connected to, or in communication with the separation channel along its entire length through thermal conduction.

Pursuant to the invention two requirements should be met in order for the separation channel to enable the rectification process.

In order for the separation channel to be able to form a head and sump, it is preferred for the ends to be situated at different height levels. In this configuration, the more volatile substances of the liquid mixture move towards the head and gather there whereas the less volatile flow into the sump. Gravity may be exploited.

In addition, steam and liquid should be kept as close as possible to a thermo-dynamic balance in the entire separation channel. With conventional rectification columns (e.g., U.S. Pat. No. 5,441,719) this is accomplished through the structural conditions in the rectification column. An appropriate column surface in addition to the column exterior wall will be fitted, whereby the system will adjust to the desired balance in the course of time; and then subsequently, be able to be operated continuously. However, in micro-fluidic channel structures there are other conditions in regard to the surface—volume ratio of the channel, so that a thermo-dynamic balance can be reached when the separation channel is specifically being heated or cooled along the entire length; in order to set the required temperature profile in the separation channel. The heating and/or cooling elements therefore should be installed along the entire or substantially the entire length of the separation channel with appropriate dimensions so that the presented liquid mixture can be separated effectively. This means that the thermo-dynamic balance at the interface between the liquid and gaseous phase must be maintained at least closely within the entire length of the separation channel.

Once the aforementioned requirements have been met, the micro-fluidic separator can be used advantageously to perform a comparably efficient separation of the components of the liquid mixture. As such, continuous operations of the separator will be possible. This will increase the throughput of the micro-fluidic separator and in relation to its size. In addition, several components of a liquid mixture may also be separated advantageously in one single separator that could lower the amount of components (one micro-fluidic rectification column instead of several distillation devices) and which may also serve as a basis for some economic solutions.

The heating and/or cooling elements may be comprised of individual elements that are distributed along the length of the separation channel and that can be controlled individually by, for example, a controller. The controller may provide for continuous operation of the device or system, for example, by continuously introducing the liquid mixture into the device, continuously passing it through the separation channel, continuously heating and/or cooling the liquid mixture, continuously vaporizing or condensing the mixture, etc. As already mentioned above it is preferable to maintain a thermo-dynamic balance as far as it is possible; this version has the advantage that the micro-fluidic separation device can be adjusted optimally to various liquid mixtures that need to be separated. With the help of the individually controllable heating and/or cooling elements, one may set any temperature profile—from the sump to head perspective of the separation channel—that is not linear and that does not depend on the physical entities of the separator (geometry, wall thickness, heat capacity). As needed, the channel can be heated with heating elements along the length of the separation channel and/or be cooled with cooling elements. The sump of the separation channel may be heated to vaporize the liquid contained in it; whereas the head of the separation channel may be cooled to liquefy the gaseous phase contained in it.

In regard to the individual heating and/or cooling elements, it is advantageous when temperature sensors are connected to and along the entire length or substantially the entire length of the separation channel through thermal conduction. This enables monitoring of the temperature profile along the length of the separation channel. With the individually controllable heating and/or cooling elements, one can react to possible temperature profile shifts and force the optimal temperature progress through appropriate control of the temperature elements. That assures that the micro-fluidic separator operates optimally.

It may be advantageous to use one temperature sensor for every heating and/or cooling element, which is connected to thermo elements with the separation channel within the thermal sphere of influence of the respective heating and/or cooling element. It is easy to establish a relation between the actual temperature around a heating and/or cooling element in the separation channel on the one hand and the heating/cooling supply provided by the heating and/or cooling element to the separation channel on the other hand. One can then react appropriately if this area of the separation channel deviates from the nominal temperature by setting the controls of the heating and/or cooling element device, which may control the heating and/or cooling elements. Again, this is especially simple when the heating and/or cooling elements and the temperature sensors allocated to one another are integrated in control loops. This has the advantage that the heating and/or cooling elements can react specifically fast to the relayed sensor signals.

The use of Peltier elements as heating and/or cooling elements may be advantageous for the separator. The advantage is that this element can heat but also cool the separation channel. Thus, the number of components can be kept advantageously low without losing possible control over the elements, which means it can heat and cool as well.

It may also be advantageous to use flow impediments for the liquid mixture in the separation channel. Those impediments may increase the internal surface in the separation channel thus increasing the interface between the gaseous and the liquid phase. The efficiency of separation is thus further increased and at the same time one may set the optimum operating point for the desired temperature at any point in the separation channel. This makes it unnecessary to optimize the internal surface of the separation channel anew for each liquid mixture.

It is further advantageous that the channel structure consists of several layers—several individual layers. Channels may be equipped with indentations in the respective surfaces of the layers and the indentations form thus connecting through-passages. This allows for manufacture of the channel structure with precision. The design with several layers lets one also build complex channel structures in simple manufacturing steps. A particular advantageous setup may feature a vaporization unit with a channel design to vaporize the liquid mixture, a separator containing the separation channel and a collection unit with at least one channel to condense a separated substance. Those layers are connected to one another appropriately where the fluidic connection will allow transfer of the liquid mixture into the individual sections of the separator. The modular design foresees the advantages of a modular system for micro-fluidic separators. For example, several vaporization units could be stocked; one then selects the most favorable for the intended application and subsequently assembles the vaporization unit with the collection unit.

Another advantage is if the layers in the intended operations of the separation unit are aligned vertically. This allows the positioning the separation channel in the surface of one of the layers, whereby the channel should be in the operational position, meaning the alignment of the separator during operation, is aligned vertically or substantially vertically. Vertical may be relative to a fixed reference point. By vertically it is meant that the device may be perpendicular to the reference point or may be at an angle of about 1 degree to about 90 degrees. The reference point may be substantially horizontal such as a table or the ground; however, other reference points may be used.

To its advantage, the heating and/or cooling element unit may be affixed to the backside and/or the forefront of the separator. A respectively large area is available there and is easy accessible for the assembling of the heating and/or cooling unit. In addition, it simplifies maintenance work and the exchange of defect heating and/or cooling elements if needed.

To further increase the efficiency of the rectification procedure one may place a condensate trap with a cooling unit at the head and a return channel for the generated condensate that leads into the separation channel. The liquid mixture captured at the head in the condensate trap can then be returned anew to the rectification process since this mixture is normally not pure with real rectification processes. However, through repeated admixture into the rectification process one does not need to discard the mixture but it is rather further separated in the continuous rectification process.

It also may be advantageous if more than two outlets are present for the separated substances. This allows for the separation of liquid mixtures with more than two components. One outlet may be needed for every envisaged substance separation; the outlet should be located within the appropriate range of temperature of the respective substance. Therefore, it may be advantageous to choose one heating and/or cooling element for each outlet. The required temperature for the envisaged substance separation should always be present when setting a respective temperature profile at the respective outlets. This once more emphasizes the advantage of the micro-fluidic separation; the geometry of the separation channel needs no readjustment for the separation procedure to work successfully. Only an appropriate temperature profile needs to be set anew.

### BRIEF DESCRIPTION OF THE DRAWINGS

For the purpose of illustrating the invention, there is shown in the drawings various forms which are presently preferred; it being understood, however, that this invention is not limited to the precise arrangements and instrumentalities particularly shown.

FIG. 1 shows a top plan view of a first embodiment of the separation device and separation system according to the present invention;

FIG. 2 shows a cross sectional view of the embodiment shown in FIG. 1, with the section taken along the line II; and

FIG. 3 shows a cross-sectional view of a second embodiment of the present invention.

### DETAILED DESCRIPTION

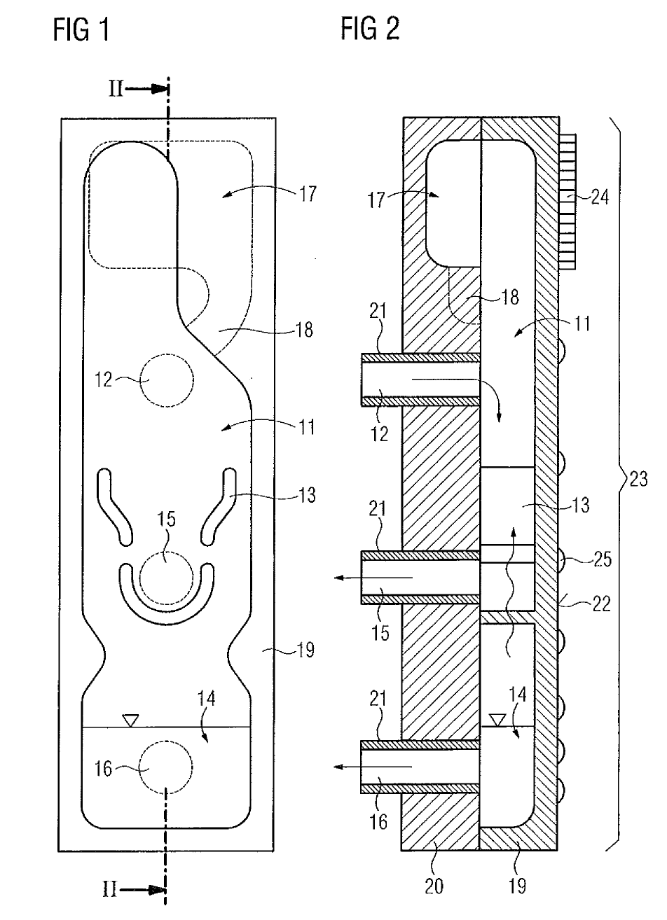

FIG. 1 shows one embodiment of a separation unit comprised of a separation channel 11. The channel 11 shown is an elongated cylinder. However, the channel may be various shapes and sizes. In particular, the channel may have a diameter larger than its length. (The channel shown in the figures has a length larger than its diameter.) In fact, the channel may not necessarily be a cylindrical shape and may be virtually any chamber capable of facilitating the separation of elements of a solution. For example, the channel may be replaced with a vessel or chamber that may be various shapes including round, rectangular, etc. As shown in FIGS. 1-3, the channel is elongated; that is, its length is greater than its diameter or cross-sectional area. This channel 11 has an inlet 12 for a liquid mixture. Liquid mixtures may be introduced into the channel via virtually any means including but not limited to pressure. Similarly, the liquid mixture may be moved through the system via pressure. Channel 11 may also comprise flow impediments 13. A liquid mixture may pass from the inlet 12, through the separation channel 11 and to a sump 14. In the separation channel 11a more volatile substance is separated and leaves the separator through a first outlet 15. In the sump 14 the less volatile liquid gathers and can be taken from the separator via a second outlet 16. A part of the liquid mixture may vaporize completely and gather in a head 17 of the separator channel 11 where the liquid mixture condenses and may be returned again through a return channel 18 to the separation channel 11.

FIG. 2 features the cross section II-II according to FIG. 1. FIG. 2 displays also a second position or layer 20 beside a first position or layer 19 illustrated in FIG. 1. As shown, the layer may be rectangular but may also be other shapes such as square, oval, round, etc. Preferably, the layers provide a sufficient surface area for heating and/or cooling elements to be positioned and effectively heat or cool the system. Second layer 20 may be similar to a lid that sits on the separation channel 11 produced in the surface of first layer 19. Layer 20 also displays the head 17, the return channel 18, the inlet 12 and the outlets 15 & 16 (these elements in FIG. 1 are scored). The outlets 15, 16 and the inlet 12 may be implemented as pipe sockets that are fitted to appropriate through-passages of position 20. Those may also serve to connect, for example, hoses.

On the lateral surface 22 of the separator that is formed by the exterior part of layer 19, heating and/or cooling elements 23 are shown. This device consists of a Peltier element 24 at the head 17 and a heating coil 25 in the area of the remaining separation channel 11, including the sump 14. The spaces in-between the heating coil windings are most dense in the area of the sump 14 since it is here where the vaporization of the liquid mixture must happen and, therefore, where the most intense heat input is required. In contrast, the separation channel should be comparably heated less; the windings' spaces in-between as such consequently continuously increase from bottom to top. The heating coil 25 lets one generate an almost linear temperature profile in the separation channel where the controllable thermal output at the heating coil provides a linear increase of the temperature progress. The cooling aspects of the Peltier element 24 can be controlled in similar ways.

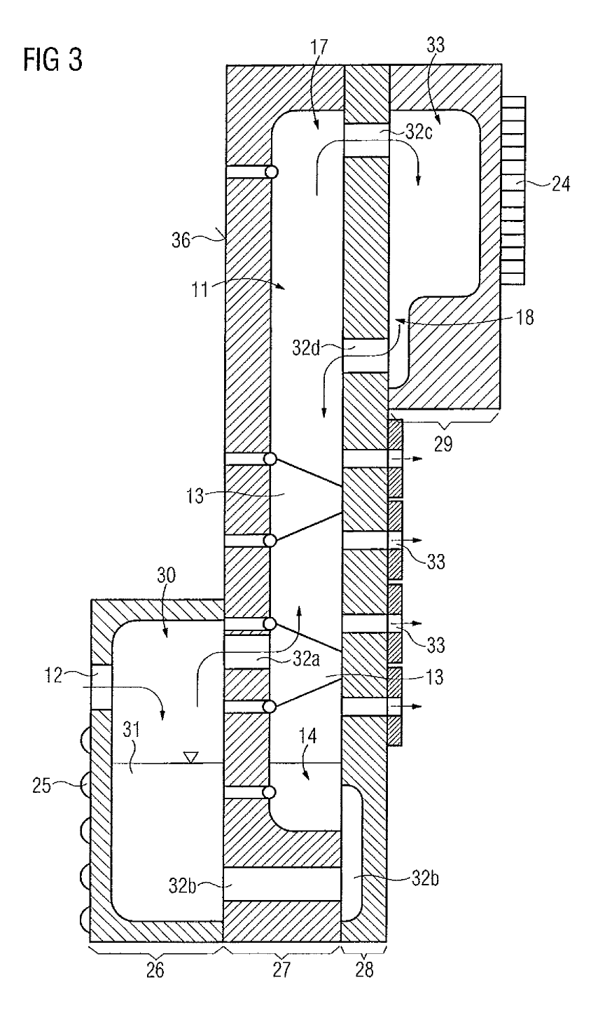

The separating device according to FIG. 3 consists of a vaporization unit 26, a separator 27, an interlayer 28 covering the separator channel 11 and a collection layer 29 that are stacked upon one another in the displayed sequence.

The vaporization unit consists of the inlet 12 and additionally a cavity 30 that serves as a supply room for the envisaged vaporization of the liquid mixture. Additionally, at the fore end of the separator, formed by the vaporizing unit 26, a heating coil 25 will be positioned; it will feed thermo-energy into the liquid mixture 31 that has gathered in the cavity 30. The vaporizing liquid mixture finds its way into the separation channel via a passage 32a that has been formed in the separator 27. As with the separator in FIG. 1, flow impediments 13 are inserted here. The sump 14 of the separation channel 11 is also connected with the cavity 30 via a passage 32b. The head 17 of the separator channel is connected with a condensate trap 33 via a passage 32c, which is implemented by the collector 29. The passage 32c is located in the interlayer which separates the separating channel 11 in the separator 27 from the condensate trap 33 in the collector 29. On the face of the separator formed by the collector 29 a Peltier element will be the cooling unit; it will enhance the formation of the condensate in the condensate trap 33. The return channel 18 is connected to the separating channel 11 via a passage 32d so that the condensate once captured can be returned to the rectification process.

The interlayer 28 is made of thereto-conducting material; e.g. Aluminum nitride; it consists in the area of the separating channel 11 of four outlets which facilitate removal of the individual substances of the liquid mixture from the separator. Each one of these outlets 33 may be equipped with a circular Peltier element; these Peltier elements can be controlled individually. Thus a temperature profile as desired for the present rectification process can be set for the separating channel; the profile does not need to be linear. To set the temperature profile and to maintain the profile during the rectification process, a temperature sensor 35 was aligned in the separator head 17, the sump 14 and in the area of each outlet 33. Electrical contacts may be formed on the face 36 of the separator 27 via conductors (not shown).

The geometric relations of the separator as shown in FIG. 3 may not be drawn to scale. In particular, the spaces between the individual outlets 33 can be much wider to assure a more exact adjustment of the desired temperature profile in the separating channel. Also, the flow impediments 13 may be allocated directly to the individual outlets 33 in order to enable efficient collection of the substance of the liquid mixture that condenses in the area of the respective outlets.

Having thus described in detail advantageous embodiments of the present invention, it is to be understood that the invention defined by the above paragraphs is not to be limited to particular details set forth in the above description as many apparent variations thereof are possible without departing from the spirit or scope of the present invention.

We claim:

1. A microfluidic separation device comprising:
a sump;
a head disposed above the sump;
a separation channel, the head and sump in fluid communication via the separation channel;
a heating element in communication with the sump;
an inlet in fluid communication with the separation channel; and
an outlet in fluid communication with the separation channel.

2. The device of claim 1, further comprising a plurality of heating elements extending along a length of the separation channel.

3. The device of claim 1, further comprising at least one cooling element in communication with the head.

4. The device of claim 1, further comprising a plurality of heating elements positioned proximate to the sump.

5. The device of claim 1, further comprising at least one flow impediment within the separation channel.

6. The device of claim 1, wherein the separation channel has two opposing ends and wherein the head is positioned adjacent one of the opposing ends and wherein the sump is positioned adjacent the other opposing end.

7. The device of claim 1, wherein the inlet is positioned above the outlet.

8. The device of claim 1, comprising two outlets, wherein the inlet is positioned above both outlets, with respect to the reference point.

9. The device of claim 1, wherein the microfluidic separation device comprises at least one substrate, wherein the substrate comprises the separation channel, head and sump and wherein the heating element is in contact with a surface of the substrate.

10. The device of claim 9, comprising a first substrate and a second substrate, wherein the first substrate comprises the separation channel, head and sump and the second substrate comprises the inlet and outlet.

11. The device of claim 3, further comprising a return channel in communication with the head and the separation channel.

12. The device of claim 11, wherein the cooling element is configured to condense vaporized liquid in the head and wherein the return channel is configured to allow the condensed liquid to return to the separation channel.

13. The device of claim 1, wherein the device is positioned at about 90 degrees with respect to a reference point.

14. The device of claim 1, further comprising a vaporization unit in communication with the separation channel, wherein the vaporization unit comprises at least one heating element and the inlet.

15. The device of claim 1, further comprising a condensate trap in communication with the head and the separation channel.

16. The device of claim 1, further comprising a plurality of outlets and at least one heating and/or cooling element adjacent each outlet.

17. The device of claim 1, wherein the separation channel is elongated.

18. The device of claim 14, wherein the vaporization unit comprises two passages in communication with the separation channel.

19. The device of claim 18, wherein one column is above the sump and the other is below the sump.

20. The device of claim 3, further comprising a controller in communication with the heating and cooling elements.

21. The device of claim 1, wherein the inlet is disposed between the sump and the head.

22. A microfluidic separation device configured to separate a mixture of at least two liquids, each having different boiling points, the device comprising:
a sump;
a head above the sump;
a separation channel positioned between the head and sump, the head and sump in fluid communication via the separation channel;
a heating element in communication with the sump;
a cooling element in communication with the head;
an inlet in communication with the separation channel;
an outlet in communication with the separation channel,
wherein the head is in communication with the separation channel via a return channel.

23. The device of claim 22, wherein the separation channel is elongated.

24. The device of claim 23 wherein the separation channel has opposing ends, wherein the head is disposed adjacent one end and the sump is disposed adjacent the other end.

25. The device of claim 24, further comprising a vaporization unit disposed at the end of the separation channel adjacent the sump, the vaporization unit in communication with the separation channel and the sump and a condensation trap disposed at the end of the separation channel adjacent the head, the condensation trap in communication with the separation channel.

26. The device of claim 22, wherein the inlet is disposed between the sump and the head.

27. The device of claim 26, further comprising two outlets wherein the two outlets are disposed below the inlet.

28. A method of using a microfluidic separation device configured to separate a mixture of at least two liquids, each having different boiling points, the device comprising:
a sump;
a head disposed above the sump;
a separation channel, the head and sump in fluid communication via the separation channel;
an inlet in communication with the separation channel; and
an outlet in communication with the separation channel,
the method comprising:
introducing into the inlet, a mixture of at least two liquids each having different boiling points;
passing the mixture through the separation channel;
heating the mixture;
collecting a substance of a more volatile liquid of the mixture in the head;
collecting a substance of a less volatile liquid of the mixture in the sump; and
passing at least a portion of the substance of the more volatile liquid or the less volatile liquid through the outlet.

29. The method of claim 28, further comprising heating the mixture as it passes along a length of the separation channel.

30. The method of claim 28, further comprising heating the less volatile liquid in the sump.

31. The method of claim 28, wherein a substance of a more volatile liquid of the mixture in the head is vapor and further comprising cooling the vapor in the head such that the vapor condenses.

32. The method of claim 31, further comprising passing the condensate into the separation channel.

33. The method of claim 28, further comprising vaporizing the liquid after introducing it into the inlet but before passing it through the separation channel.

34. The method of claim 33, further comprising vaporizing the liquid in the sump.

35. The method of claim 34, further comprising introducing the vaporized liquid from the sump into the separation channel.

36. The method of claim 29, further comprising setting a temperature profile along the length of the separation channel.

37. The method of claim 28, wherein the microfluidic separation device comprises at least two outlets, the method further comprising passing a more volatile substance of the liquid mixture from one outlet and passing a less volatile substance of the liquid mixture from the other outlet.

38. A method of using a microfluidic separation device configured to separate a mixture of at least two liquids, the device comprising:
a sump;
a head disposed above the sump;
a separation channel, the head and sump in fluid communication via the separation channel;
an inlet in communication with the separation channel; and
an outlet in communication with the separation channel,
the method comprising:
continuously introducing into the inlet, a mixture of at least two liquids;
continuously passing the mixture through the separation channel;
continuously heating the mixture;
continuously collecting a more volatile liquid of the mixture in the head;
continuously collecting a less volatile liquid of the mixture in the sump; and
continuously passing at least a portion of the substance of the more volatile liquid or the less volatile liquid through the outlet.

39. The method of claim 38, wherein a substance of a more volatile liquid of the mixture in the head is substantially vapor and further comprising continuously cooling the vapor in the head such that the vapor condenses.

40. The method of claim 39, further comprising continuously passing the condensate into the separation channel.

41. The method of claim 38, further comprising continuously substantially vaporizing the liquid after introducing it into the inlet but before passing it through the separation channel.

42. The method of claim 41, further comprising continuously vaporizing the liquid in the sump.

43. The method of claim 42, further comprising continuously introducing the vaporized liquid from the sump into the separation channel.

44. A microfluidic separation device for continuously separating components of a solution, the device comprising:
a separation chamber;
an inlet in communication with the separation chamber;
an outlet in communication with the separation chamber; and
a heating or cooling element in operative communication with the separation chamber.

45. A method for continuous solvent exchange and separation of a solution comprising different components, using a microfluidic separation device comprising:
a separation chamber;
an inlet in communication with the separation chamber;
a plurality of outlets, each in communication with the separation chamber; and
a heating and/or cooling element in operative communication with the separation chamber,
the method comprising:
continuosly introducing the solution into the separation chamber through the inlet;
continuously heating and/or cooling the solution in the separation chamber with the heating and/or cooling element to continuosly separate components from the solution;
continuously passing at least one of the separated components from one outlet; and
continuously passing another one of the separated components from one outlet.
